(19) United States
(12) Patent Application Publication
(10) Pub. No.: US 2008/0066188 A1
(43) Pub. Date: Mar. 13, 2008

(54) Identity verification system

(76) Inventor: Dusic Kwak, Lorton, VA (US)

Correspondence Address: MAIER & MAIER, PLLC, 1000 DUKE STREET, ALEXANDRIA, VA, 22314, US

(21) Appl. No.: 11/524,954

(22) Filed: Sep. 22, 2006

Related U.S. Application Data
(60) Provisional application No. 60/836,146, filed on Aug. 8, 2006.

(51) Int. Cl. H04L 9/32

(52) U.S. Cl. 726/28

(57) ABSTRACT

A method and system for certifying the identity of a party. The method and system may include a first party transmitting an electronic message that is ultimately intended for a second party to an identity verifying party. The identity verifying body may use data contained in the electronic message to transmit the message to a distribution center geographically proximately located to the second party. A delivery person associated with the distribution center may then deliver the message to the second party and obtain identification data, which may be relayed back to the first party. Additionally, the method and system may be used to disseminate mass mailings through both electronic and traditional mail.

### CROSS REFERENCE TO RELATED APPLICATIONS

This application claims priority under 35 U.S.C. §119(e) of U.S. Provisional Application No. 60/836,146, entitled “Email Certification System” and filed Aug. 8, 2006, the entire contents of which are hereby incorporated by reference.

### BACKGROUND

The background for this application relates generally to electronic mail (email) and the transmission thereof. There are many different types of known email transmission systems, interfaces and devices allowing for the transmission of data from a first party to an intended recipient. Different types of systems employ various types of embedded software or programs to determine whether or not an email has been delivered, whether or not an email has been opened, whether or not a person opening the email has authorization to open the email and other email-specific data and queries.

Email offers a variety of distinct advantages over other message delivery methods, such as traditional “snail mail” or facsimile. Traditional mail, and the similar courier, delivery and shipping services, can take a period of several days to reach a recipient and typically incorporates a variety of expenses, such as postage, associated with each message desired to be sent. Facsimile messages typically take longer to print, scan and send than do regular email messages. Additionally, facsimile messages are typically delivered to a single location in, for example, an office, as it would not be desirable or cost effective to provide a variety of fax machines and associated phone lines for every potential facsimile recipient.

Conventional mail and facsimiles can, however, provide a sender with evidence indicating that they have both sent a message and that a message has been received. In the case of conventional mail, a sender may obtain a receipt for the postage they paid to mail or ship a message and then receive a return message signed by the intended recipient or a proxy for the intended recipient. Additionally, the U.S. Postal Service and many shipping and courier services and agents also offer online tracking of mail and packages, so that a sender may determine the location and status of their message or package through the use of the Internet. Similarly, a fax machine can provide a sender with a print out showing that a fax was transmitted to another fax machine, and whether or not the fax was transmitted. Additionally, the receiving fax machine can provide a “delivered receipt” either by automatic return fax or through the manual sending of a return receipt by a party associated with the receiving fax machine.

With traditional email systems, however, there is no definitive way to know whether or not an email has been properly delivered or opened. In some email systems, a sender may track whether or not their email has been delivered or opened through the use of delivery receipts and opened or read receipts. Delivery and read receipts, however, are often not compatible or allowed across different networks or different types of email providers or email interfaces. Additionally, when delivery or read receipts are generated, it is impossible to tell whether or not the intended recipient has actually opened and viewed the email his or her self.

Another issue with email is that the true identity of the recipient of an email is desired, particularly in instances of electronic commerce (e-commerce). However, as described above, it is often difficult and many times impossible to determine if an email has been delivered and whether or not the party to whom the email was delivered was the proper and intended recipient of the email. This is a result of the relative anonymity available to people online as well as the lack of means that exist for verifying the transmission, delivery and opening of an email across different email servers or different email programs, as discussed above.

Online fraud is another problem facing consumers and businesses. The fraud can occur in any of a variety of forms, such as the posting of ads without having any real products to sell, the sending of fake or otherwise improper payments or the receipt of goods or services without any payments. One reason these types of fraud are rampant on the Internet is due to the aforementioned anonymity that exists between the vendors and consumers. Consumers can often purchase goods or services by clicking a few links or buttons on an Internet website, submitting form data or by sending an email, none of which require speaking to the vendor or having any type of physical contact with them. Similarly, an online retailer does not need to have a brick and mortar storefront as they may utilize a post office box, thereby eliminating any physical address for consumers to visit and preventing actual consumer-retailer contact or communication.

Another problem with online commerce is that many people maintain different identities online than they do in real life, utilizing “handles” or nicknames on websites that do not reveal a real identity or location. Additionally, due to hacking and schemes such as “phishing”, where one party obtains another party's information, such as name, credit card number and social security number through fraudulent means, it can appear as if a proper transaction is being conducted when in fact the person acting as the consumer or the vendor is using a stolen identity and information.

Although most consumers and online retailers and vendors are not involved in fraudulent behavior or scams, it may be desirable for both consumers and retailers/vendors to verify the identities of the parties involved in online transactions and e-commerce. However, there is currently no way to properly identify and verify the identity of people involved in online or Internet commerce or dealings.

Previous systems exist where an email is sent to multiple recipients and the original sender can receive a delivery status notification containing a protocol-specific delivery status code for each of the one or more recipients that received the message, although no further information about the identity of the recipients is generated or transmitted. Another previous system describes a system where a user of a particular email service can receive a return receipt after sending email to a variety of addressees. Again, however, this system does not include a way to determine if the proper parties actually receive the message, nor does it include any further information about the parties receiving the message.

### SUMMARY OF THE INVENTION

An embodiment of the invention includes a system and method for verifying the identity of a party receiving an email and certifying the identity of an individual sending an email in letter format. A message may be drafted by an originating first party. This message may be infused with data concerning the physical address and other relevant information of the intended recipient of the message. The message may then be transmitted to an identity verifying party. The identity verifying party may access data housed in the electronic message to determine the location of a distribution center geographically proximate to the intended recipient of the message. At the distribution center, a delivery person may deliver a hard copy of the electronic message to the intended recipient. At the time of the delivery, the delivery person may request identification and other data from the intended recipient and, depending on the data provided, delivery the message and report back to the originator of the message.

In another exemplary embodiment, a system and method for the mass distribution and dissemination of a message is disclosed. In this exemplary embodiment, a message originator may draft a message intended for a variety of recipients. The message may contain data related to the delivery preferences of the recipients as well as the addresses of the recipients. The message may be transmitted by the originator to a centralized location. At the centralized location, data may be retrieved from the message indicating the delivery preferences of the intended recipients, as well as the address information of some of the intended recipients. The centralized location may then electronically forward the message to any recipients that have previously agreed to the electronic receipt of message. The original message may then be transmitted to a distribution center that is geographically proximate the other recipients, who may have previously agreed to receive hard copies of messages. The distribution center may then deliver hard copies of the messages to the appropriate recipients.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary diagram showing an identity verification system.

FIG. 2 is an exemplary flow chart showing the steps involved with an identity verification system.

FIG. 3 is an exemplary diagram showing a data entry interface.

FIG. 4 is an exemplary diagram showing a message distribution system.

FIG. 5 is an exemplary flow chart showing the steps involved with a message distribution system.

FIG. 6 is an exemplary flow chart describing a message transmission system.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

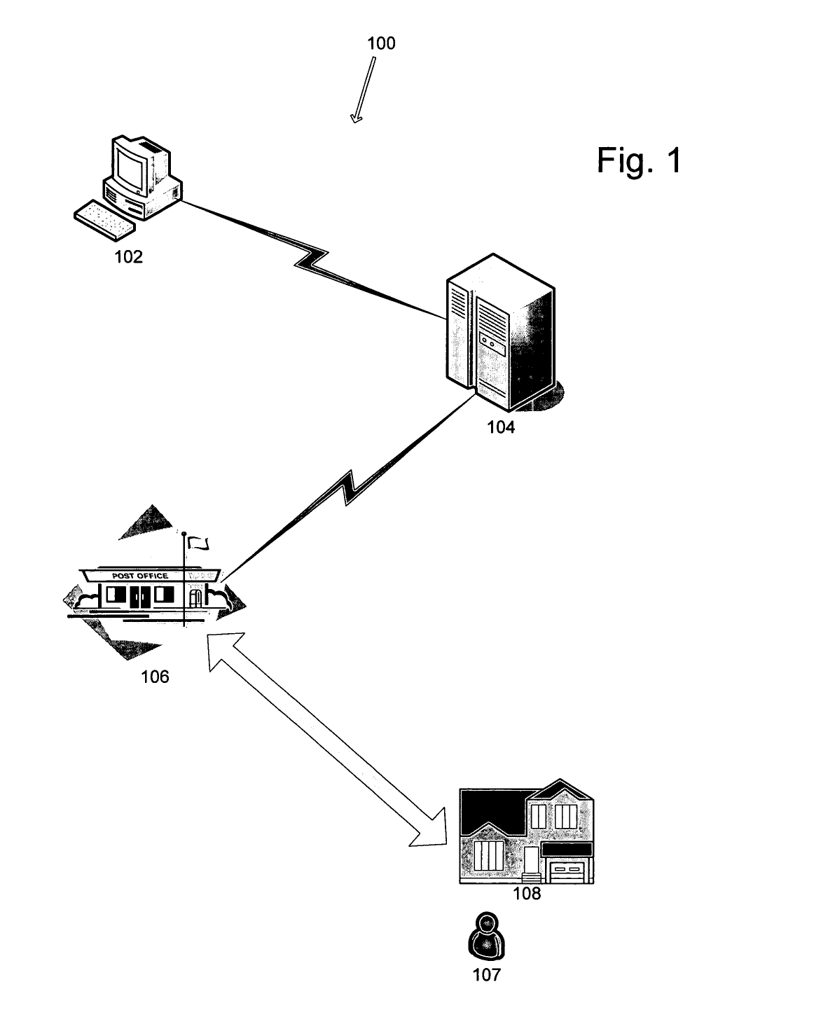

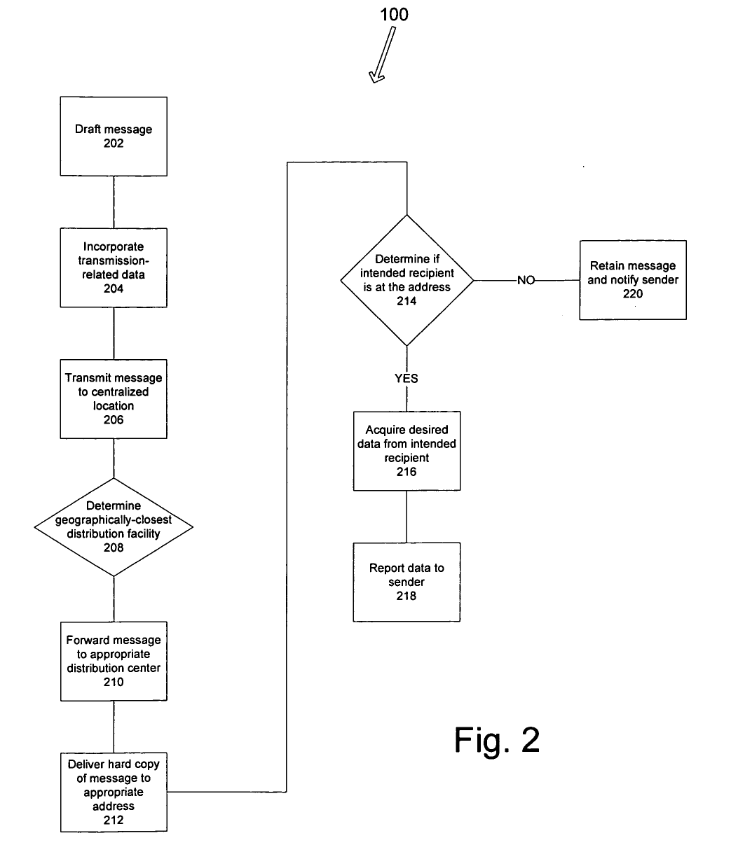

In one exemplary embodiment, a method and system for quickly verifying the identity of a person involved in an online or electronic transaction is disclosed. FIGS. 1 and 2 show an exemplary manner in which the identity of a consumer or vendor/retailer in a transaction may be determined or verified. In this system 100, a person located at a computer 102 or other device capable of generating an email, for example a personal computer, laptop/notebook, PDA, cell phone or the like, may desire to verify the identity of a person, for example a person at the other end of a transaction they may enter into or into which they have already entered. For example, the person may be a consumer who has found an online retailer with whom they wish to purchase a product or service. Alternatively, the consumer may have found an online ad, such as a classified ad, or an auction, such as through eBay® or Yahoo Auctions®, with an individual who is selling one or more pieces of their personal property or some other service that they provide as an individual. If the consumer has not transacted business with the online retailer previously, they may desire to verify the identity and physical address of the online retailer in order to prevent possible scams or fraud. Similarly, due to the nature of online classified ads, the consumer will most likely not have conducted any previous business with the poster of the online classified ad; therefore they may desire to ascertain and verify the exact identity and location of the party who posted the ad. Once the identification of the online retailer or other second party with whom the consumer or first party wishes to conduct business is verified, it is less likely that the there will be fraud or any type of scam. However, if the identity of the online retailer or second party is verified and there is still a scam or fraud, the consumer has a greater potential for legal recourse and remuneration. Further, if the identity of the second party is not capable of being ascertained, there may be a higher likelihood of some type of scam or fraud, so the consumer may desire to cancel or forego the transaction.

Alternatively, an online retailer or person who posted a classified ad or auction may wish to verify the identity of a consumer or person who contacts them in order to conduct business with the online retailer or who intends to purchase the contents of the online ad or auction. In these situations, the retailer may desire to ascertain the identity of the consumer so as to avoid certain problems, such as shipping a product without receiving payment or to avoid well known scams, such as using false money orders or stolen credit card numbers.

Thus, in this embodiment, system 100 may be used in order to verify the identity of another party. Therefore, the first party, for example a consumer, may, in step 202, draft a message and transmit the message from workstation 102 to a third party, in step 206. The third party could be the identity verifying party and utilize an email or electronic message server or retrieval system 104 in order to accept and extract data from electronic messages sent from the first party. The identity verifying body may be any centralized clearing house having an email server. In one exemplary embodiment, the centralized clearing house can be a large mailing or shipping entity, such as the United States Postal Service (USPS), Federal Express (FedEx), United Parcel Service (UPS), DHL or the like. In another embodiment, the centralized clearing house could be an entity that facilitates transactions between separate parties, such as eBay® or Yahoo®. Additionally, in step 204, prior to the transmission of the email in step 206, transmission-related data, such as personal information and address data of the intended recipient of the message, may be incorporated.

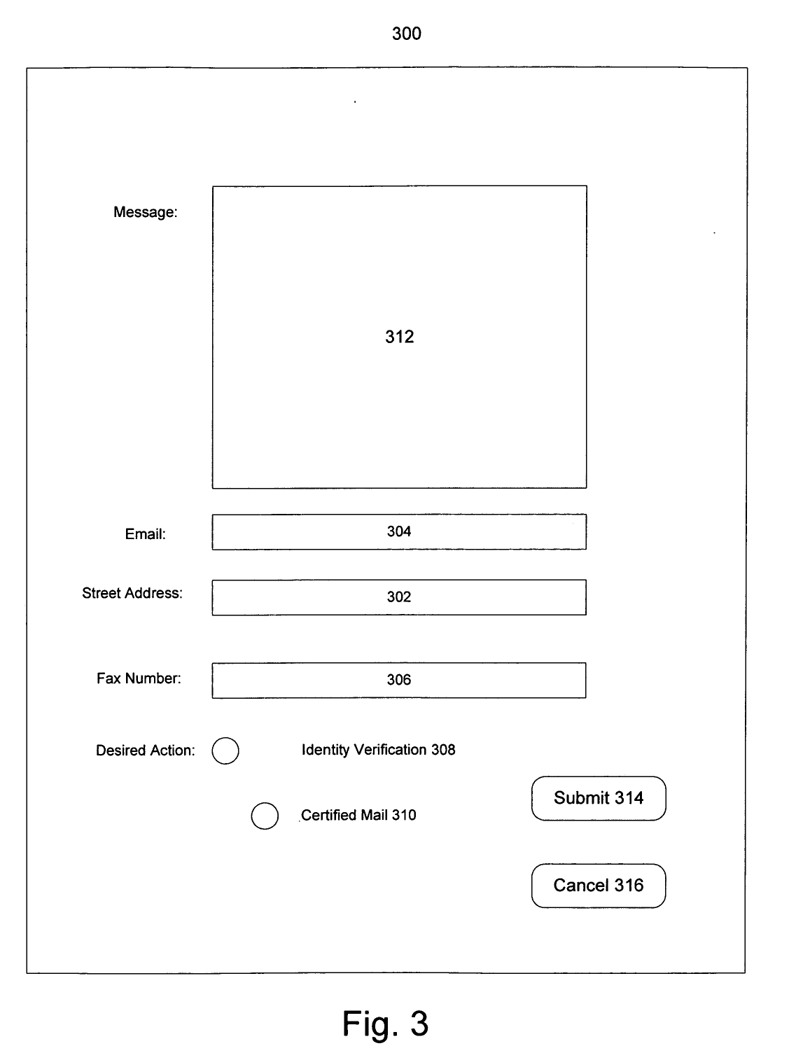

The email originated by the consumer may be sent from an online interface or any email program. An example of an interface is described with respect to FIG. 3, which allows a user to enter in additional data to be transmitted, opened and read by the third party verifiers. Thus, the third party could maintain a website or other internet interface 300 that allows a user to enter and transmit email, for example in steps 204 and 206, from the interface or a user could transmit and send an email from a desired email program or interface, for example Microsoft Outlook® or Yahoo Mail®, and either include additional data for the third party or have a third party program running in conjunction with the desired email program or interface or on top of the desired email program or interface.

As described with respect to FIG. 3, the email program or interface 300 may include one or more data entry sections that may be incorporated in any of a variety of manners. In one exemplary embodiment, the data entry section can be disposed at the bottom of the email program or interface. In another exemplary embodiment, a data entry screen may be presented when a person chooses an option to draft a new email or message or when they choose to reply to a message. Alternatively, the data entry screen could be presented after a person chooses to send an email. The data entry screen or data entry section may have a similar appearance to that shown in FIG. 3. This screen or section of a screen can include a field for entering the physical address 302 the email address 304 and/or other information, such as a facsimile number 306 or other personal information of the party drafting the email, and an area 312 for drafting a message. Also included may be fields for entering the physical and email addresses and/or personal information of the intended recipient of the email. Additionally, other options, such as the type of action to take 308, delivery desired 310 and payment methods may have fields for that information or radio buttons used to select various options. Some of the delivery options may include certified mail, restricted mail and registered mail, as well as any other type of mail delivery option known to one having ordinary skill in the art at the time of the invention. Additionally, any known payment option may be represented, such as credit card or electronic payment options, such as Paypal®, or any other payment method known to one having ordinary skill in the art. Additionally, parties using this method and system may set up accounts with the third party certifying body prior to performing any transactions. Finally, interface 300 may have buttons (e.g. buttons 314 and 316) used to submit or cancel the data entered into the interface.

After the message originating party sends the email, it is transmitted to the third party identity verifier at location 104. The third party 104 can then determine the geographically closest distribution facility to the intended recipient of the message in step 208, and forward the email to a distribution point 106, in step 210, that is located physically near the street address of either the office or home of the retailer or vendor 108. For example, if the identity verifying party is the USPS, the email may be received at a centralized email server and then routed to the closest local post office in the town or city where the retailer or vendor is located. Alternatively, if the identity verifying party is FedEx, UPS, DHL or some other shipping company, the email could be received at a centralized location and then forwarded to the distribution center closest to physical address of the vendor or retailer.

After the email is received at the location 106 of the identity verifying party 104 nearest the vendor or retailer, the identity verifying party 104 may print and package the message, for example in an envelope, and then deliver the message to the physical address 108 of the vendor or retailer by dispatching a mail carrier or delivery person 107 in step 212. In step 214, the delivery person 107 could determine if the intended recipient of the message is located at the address corresponding to location 108. The delivery of the message could also be such that the identity of the party to whom the message is being delivered would need to be verified in order for delivery to be accepted. Thus, the message being delivered could be delivered similarly to certified mail that requires that the party receiving the delivery verify their identity and provide a signature in order to receive the delivery. Many delivery companies and organizations, such as the USPS, FedEx®, UPS®, DHL® and others offer this type of service.

Thus, in this exemplary embodiment, when the mail carrier or delivery person 107 delivers the message to the intended person at the appropriate address 108, the intended person or, alternatively, the intended person's authorized agent, may accept delivery of the message upon providing proof that they are the intended recipient or an appropriate agent of the intended recipient of the message. The delivery person 107 may then acquire any desired data from the recipient of the message in step 216. For example, following the furnishing of the proof of identification, the intended recipient of the message may also provide their signature in order to receive the message. In a further exemplary embodiment, the mail carrier or delivery person 107 may also take a picture, for example a digital photograph, of the intended recipient of the message. In yet another exemplary embodiment, the mail carrier or delivery person 107 may take fingerprint data of the intended recipient of the message. In this exemplary embodiment, mail carrier or delivery person 107 may carry any of a variety of fingerprint-taking devices that are known in the art, such as traditional ink and paper or digital fingerprint scanners. Alternatively, in another exemplary embodiment shown in step 220, the delivery person 107 may not deliver the message to location 108 if there is no one present to receive the message or if the person attempting to receive the message does not furnish the appropriate information.

After the delivery of the message to the intended recipient, the mail carrier or delivery person 107 may input the data acquired in step 216 and any additional data required by the transaction, such as time of delivery, and, in step 218, transmit that data, including a record that the recipient furnished proper identification and the signature of the recipient, to the post office branch or distribution center 106 from which the mail carrier or delivery person, respectively, was dispatched. This data may be transmitted through a wireless device or through any other type of handheld or portable device that may transmit data to a centralized location 104. The delivery data may then be transmitted to the first party originator 102 of the email in any of a variety of manners known to one having ordinary skill in the art.

In one further exemplary embodiment, the delivery data may be emailed directly to the originator 102 of the email. Alternatively, the delivery data may be uploaded to an Internet site where the originator 102 of the email may access the data. Using this data, the originator 102 of the email can verify the identity and location of the person with whom they are doing business or with whom they may do business. Additionally, this identity verification can take place in a very short amount of time, for example twenty four hours or less. The identity verification can take place in under twenty four hours due to the hybrid combination of electronic mail (email) and regular mail. Instead of following the typical path of sending registered, certified and/or restricted mail from a post office or post office branch location, a person desiring to send their mail and verify the identity of the party to whom they are corresponding may just send an email or electronic message through an email program or electronic message interface on the Internet. Due to the speed at which email and electronic messages on the Internet may be transmitted, the message may be received at a centralized location and forwarded to a location physically proximate to an intended recipient nearly instantaneously. Once at the physically proximate location 106, such as a post office branch office or distribution center of a shipping company, the message may be delivered at the time of the regular mail delivery or at the time of any regular package or shipment delivery by the delivery person 107. Thus, in many situations, a person may be able to verify the identity of the party with whom they may or currently are transacting online business in significantly less than twenty four hours. Additionally, the costs associated with this method and system of verifying the identity of someone are significantly lower than other methods known in the art. Further, this method could decrease the amount of postage or decrease the shipping costs as well as decrease the amount of time needed by a party to send messages that typically need to be mailed long distances. Similarly, costs to the mail service or shipping company would not be significantly high due to the messages being delivered during the typical route of a mail carrier or delivery person.

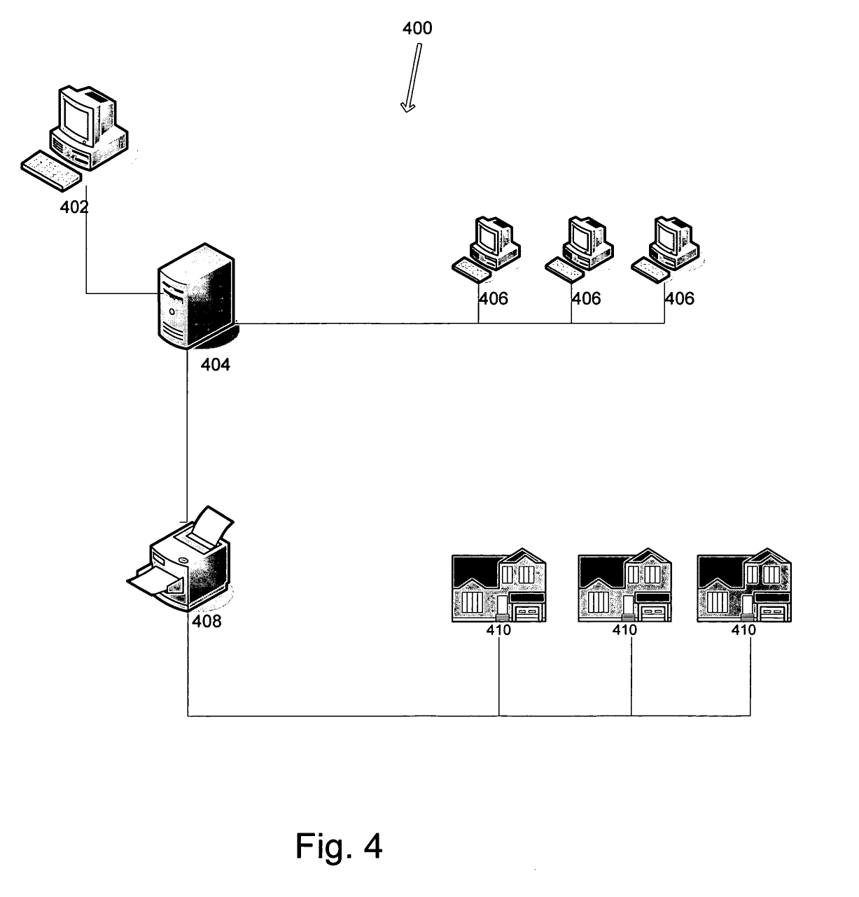

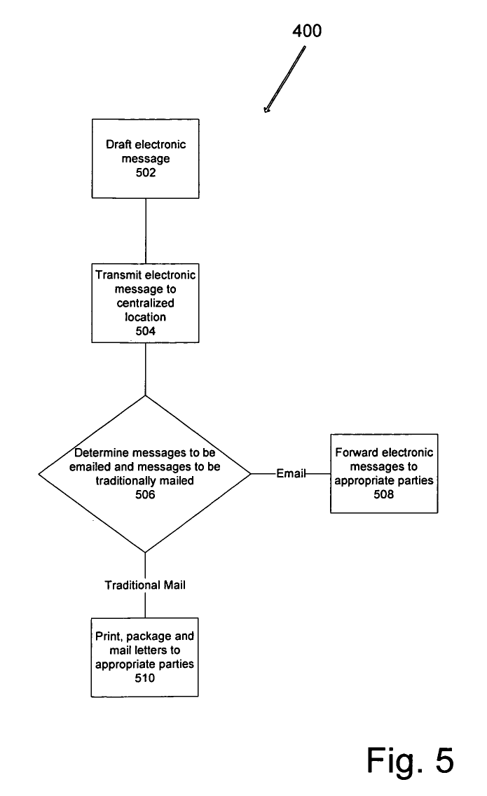

In another exemplary embodiment, as shown in FIGS. 4 and 5, a system and method similar to that described above can be used to cheaply disseminate large amounts of mail. Thus, using system 400, a person may generate a message and distribute it to people via email and traditional mail. In this embodiment, a user 402 may once again draft (step 502) and transmit (step 504) an email from either an email program or an online interface, to a centralized location 404. However, in this exemplary embodiment, the email or electronic message may contain data that indicates the sender of the message desires to have the message mass-distributed to a certain market. Further, the message may contain data regarding whether or not the message should be forwarded electronically, for example forwarding the message electronically to recipients 406 or via traditional delivery means, such as regular mail, to recipients 410. The sender 402 of the message may therefore have the message disseminated to, for example, several hundred, several thousand, or any other number of addresses. Thus, central location 404 can review the message data and decide, in step 506, whether to simply forward the message electronically to recipients 406, as in step 508, or, in step 510, forward the message to a distribution center 408 located nearest the area. At distribution center 408, the message 408 can be printed, copied, as are desired by the original sender of the message, and then, in step 512, distributed to the desired addresses 410. This can allow for the mass distribution of a message or messages within an area without requiring the party originating the message to address and mail each message individually. Additionally, it could save postage and delivery fees for the mass distribution of messages in geographically distant areas. Further, it could be combined with the above-described embodiments to allow for the identities of multiple receiving parties to be verified. Additionally, this could allow people to more effectively communicate and market to areas where they may not otherwise be able to access.

Also, the previously described embodiment could be used to improve the efficiency of current mass-communication methods. For example, in many schools mass mailings are often used to alert the parents of students of upcoming events, changes in school policies or other school-related items. These mailings frequently require a significant expenditure of time, money and manpower for the schools' personnel. Therefore, in a further exemplary embodiment, a person or organization, such as a school, could send out mass-mailings in a hybrid email and traditional mail format. In this embodiment, a system could be implemented whereby an organization could send an electronic message to a centralized location, for example location 404, and the centralized location 404 could attend to either forwarding the electronic message to the appropriate parties or the forwarding of mailed letters to the other parties.

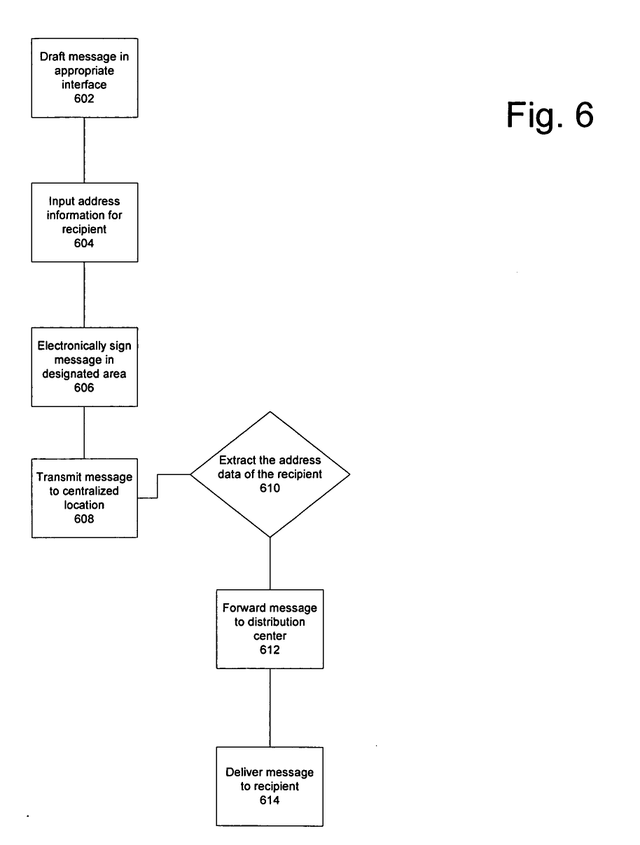

In yet another exemplary embodiment shown in FIG. 6, an email program or client may be used as a replacement for traditional word processing programs. Traditional word processing programs, such as Microsoft Word® and Corel Wordperfect®, are used on almost every personal computer. A commonplace use for these word processing programs is the generation of personal and professional letters and mail. However, in order for one to mail a letter that they draft using one of these word processors, the letter may have to be printed, signed, sealed in an envelope, have postage added and deposited with the appropriate delivery party, be it the USPS or one of the shipping agents described previously. Additionally, at most types of businesses, this process often requires a variety of people: for example one person drafts the letter, another person signs the letter, another person seals the letter in an envelope, another person deposits the letter at the post office or shipping agent and yet another person delivers the letter

Thus, in this exemplary embodiment, an email program or interface may be used as a substitute for a word processor and the associated steps and people required in mailing a letter or message. Any email program or interface, including those previously described, may be used to create a typed message, as in step 602. One exemplary embodiment may use an email program or a plug-in program associated with the USPS or any shipping entity, as described previously. Additionally, address information and other personal information regarding the intended recipient may be entered in step 604. The address information may be entered in separate fields designated for address information, or may be entered in a standard heading area. If the address information is entered in a standard heading area, this information may later be extracted by a third party in order to properly deliver the message. The email program or interface may also contain an area, such as a dialogue box or other dedicated area, where one could incorporate their signature (step 606) into the email. For example, a dialogue box could be disposed below the field where text is entered by the author of the email. The dialogue box could be based on a program similar to Adobe Illustrator® or Macromedia Freehand®, where a user can translate the movements of a cursor directly to a display using a program. Thus, in this example, a person could use a computer peripheral, such as a mouse, stylus or the like to sign an email with their actual signature in step 606. Thus an email may now have a similar seal of authenticity as a typical letter that is signed.

After a person drafts their message and signs the message in the appropriate area using a computer peripheral, the electronic letter can be transmitted, in step 608, to a centralized location, similar to that described in previous embodiments. Additionally, prior to sending the electronic letter, the author may choose any of a variety of delivery options, such as certified mailing, restricted mailing or registered mailing, or any other type of mailing. Using personal and address information extracted from the email or electronic message in step 610, the message may then be transmitted, in step 612, to a postal facility or shipping distribution facility geographically near the address of the intended recipient of the letter. The letter may then be printed and sealed, for example in an envelope, and then delivered, in step 614, to the intended recipient during the routine course of deliveries. When the letter is delivered, other actions may be pursued, such as the identity verification discussed above. Additionally, depending on options selected by the author of the electronic letter, a return receipt may be generated and transmitted to the author or information about the recipient of the letter may be transmitted to the author of the letter. Also, this exemplary embodiment may be used during the mass mailing of letters, similar to the embodiment described previously.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for verifying the identity of a person, comprising:
obtaining identification information about a second party;
drafting, by a first party, an electronic message to the second party;
transmitting the electronic message to a third party;
forwarding the electronic message from the third party to a distribution center located geographically proximate the physical address of the second party;
delivering a hard copy of the electronic message to the second party;
checking the identification data of the second party at the time of delivery;
recording data related to the second party and the delivery of the electronic message;
transmitting the data related to the second party and the delivery of the electronic message to the first party; and
comparing the identification data of the second party obtained before the drafting of the electronic message with the identification data of the second party obtained during the delivery of the electronic message.

2. The method of claim 1, wherein the first party can electronically add their signature to the electronic message.

3. The method of claim 2, wherein an interface used to draft the electronic message includes a graphical input box that allows the first party to use a computer peripheral device to write their signature.

4. The method of claim 3, wherein the computer peripheral device is a stylus.

5. The method of claim 1, wherein the third party is a shipping agent.

6. The method of claim 1, wherein the third party is an entity that facilitates transactions between separate parties.

7. The method of claim 1, further comprising accessing an online interface from which the first party drafts and transmits the electronic message.

8. The method of claim 7, wherein the online interface is maintained by the third party.

9. The method of claim 7, wherein the online interface is an Internet-based email program.

10. The method of claim 9, wherein the online interface has the functionality of a word processor.

11. A method of distributing messages, comprising:
entering a message intended for a variety of recipients into an electronic interface;
transmitting the message to a third party;
determining parties to receive the message via email;
determining parties to receive a hard copy of the electronic message;
forwarding the message via email to parties agreeing to receive emailed messages;
printing and delivering the message to parties agreeing to receive mailed messages.

12. The method of claim 11, wherein the electronic interface is an online interface maintained by a shipping agent.

13. The method of claim 11, wherein the electronic interface is an email program.

14. The method of claim 11, wherein address information and delivery preferences for the variety of recipients are embedded in the message as entered transmitted to the third party

15. The method of claim 13, wherein the variety of recipients are given the option of changing their delivery preference upon receipt of the message.

16. A system for transmitting messages, comprising:
an electronic message drafted by a message originating party, intended for an intended recipient of the message and containing information regarding the intended recipient;
a third party located remotely from the message originating party and the intended recipient; and
a message distributor located geographically proximate to the intended recipient; wherein
the message originating party transmits the message to the third party, the third party extracts information about the intended recipient from the message and forwards the message to the message distributor, the message distributor prints and packages the message, requests and records identification data from the intended recipient, delivers the message to the intended recipient, and transmits the identification data from the intended recipient to the message originating party.

17. The system of claim 16, wherein the information regarding the intended information is any known identification information of the intended recipient and the address information of the intended recipient.

18. The system of claim 16, wherein the third party extracts the address data of the intended recipient from the message and forwards the message to a message distributor located geographically close to the intended recipient.

19. The system of claim 16, wherein the electronic message is drafted using an online interface.

20. The system of claim 16, further comprising means for adding the signature of the message originating party to the message.
